(19) United States
(12) Patent Application Publication
(10) Pub. No.: US 2025/0206240 A1
(43) Pub. Date: Jun. 26, 2025

(54) RECREATIONAL VEHICLE, IN PARTICULAR A MOTORHOME, WITH HYBRID INSULATION, AND HYBRID INSULATION

(71) Applicant: Thor Tech, Inc., Elkhart, IN (US)

(72) Inventors: Pascal Hofmann, Wolfegg (DE); Michael Gnann, Fischbach (DE); Hannes Hoermann, Bad Waldsee (DE); Michael Beermann, Lindenberg (DE)

(73) Assignee: Thor Tech, Inc., Elkhart, IN (US)

(21) Appl. No.: 18/987,701

(22) Filed: Dec. 19, 2024

(30) Foreign Application Priority Data
Dec. 22, 2023 (DE) 102023136678.5

(51) Int. Cl. B60R 13/08

(52) U.S. Cl. CPC B60R 13/0815; B60R 13/0876; B60R 2013/0807

(57) ABSTRACT

The invention relates to hybrid insulation for a recreational vehicle, in particular a motorhome or a caravan, with at least one mat element based on a plastics foam mat. It is proposed that at least one cover element based on a fiber material is provided. Furthermore, a recreational vehicle, in particular a motorhome or a caravan, comprising such a hybrid insulation is provided. Furthermore, a method for adapting an insulation for a recreational vehicle, which insulation has mat elements based on a plastics foam mat, is provided, wherein a part of the mat elements is replaced and optionally supplemented by cover elements based on a fiber material to form a hybrid insulation according to any one of claims 1 to 8.

The invention relates to a recreational vehicle, in particular a motorhome, with hybrid insulation, and to hybrid insulation for recreational vehicles.

In a motorhome, PU foam mats with adhesive backing can be glued to the chassis outer panels. The plastics foam mats made of polyurethane (PU) are used as roll material or as cut pieces adapted to the vehicle contour.

However, PU foam mats usually do not insulate over large areas and the protective film on the adhesive backing creates waste. Due to many individual parts and no precise assignment, correct bonding is complex. In addition, the insulation cannot be corrected once the adhesive has come into contact with the vehicle. Cold chamber tests have shown that the heating time with lower-performance heaters is too long.

The object of the invention is to provide hybrid insulation, a recreational vehicle, in particular a motorhome or a caravan, and a method which allow for an improved design and improved functionality.

The object is achieved by hybrid insulation having the features of independent claim 1, a recreational vehicle having the features of claim 9 and a method having the features of claim 11. Advantageous further developments of the invention are given in the sub-claims. In particular, a reduction in the heating time for an interior space can be achieved.

The object is achieved by a hybrid insulation for a recreational vehicle, in particular a motorhome or a caravan, with at least one mat element based on a plastics foam mat, wherein at least one cover element based on a fiber material is provided.

The object is further achieved by a recreational vehicle, in particular a motorhome or a caravan, with at least one such hybrid insulation.

Furthermore, the object is achieved by a method for adapting an insulation for a recreational vehicle, which insulation has mat elements based on a plastics foam mat, wherein a part of the mat elements is replaced and optionally supplemented by cover elements based on a fiber material to form such a hybrid insulation.

It is advantageous that the plastics foam mat is formed at least substantially from a polyurethane. This makes it possible to insulate certain areas using a PU foam mat. This allows advantageous insulation to be achieved, for example, on larger, flat surfaces.

It is advantageous that the fiber material comprises fibers made of polyethylene terephthalate and/or fibers made of polypropylene. This allows advantageous properties to be utilized.

It is advantageous that the fiber material is formed at least substantially from fibers made of polyethylene terephthalate and/or fibers made of polypropylene. This allows advantageous properties to be realized.

It is advantageous that the fiber material is at least partially designed substantially as a covering fleece which in particular is formed at least substantially from fibers made of polyethylene terephthalate. This makes it possible to achieve a good balance between differently dimensioned installation geometries.

It is advantageous that at least one cover layer, preferably both cover layers, of the fiber material is or are designed as a cover fleece which in particular is formed at least substantially from fibers made of polyethylene terephthalate. This allows for improved adaptation to contact surfaces on the recreational vehicle, in particular walls or a body.

It is advantageous that a core of the fiber material is formed at least substantially from hard and/or mechanically stable fibers, in particular at least substantially from fibers made of polypropylene. In this way, a high degree of shape retention and a high level of support can be achieved.

It is advantageous that the fiber material in the expanded state has a material thickness between about 2 cm and about 8 cm, in particular between about 2.7 cm and about 6 cm, further in particular between about 3.4 cm and about 4.9 cm, further in particular between 3.7 cm and 4.5 cm, further in particular about 4.1 cm. In this way, the insulating effect can be optimized in terms of material consumption or material costs.

It is advantageous that the at least one cover element can be mounted without adhesive and/or by insertion without a direct integrally bonded connection. This makes it easy to replace in the event of repairs. Furthermore, waste is avoided in advance by using adhesive tape covers or the like.

It is advantageous that the at least one cover element is mounted in such a way that it can be removed non-destructively. This allows for easy removal in case of repairs or similar.

It is advantageous that the at least one cover element can be fastened mechanically, in particular by clips and/or screws. This allows for assembly which allows for easy disassembly without leaving any residue.

It is advantageous that the at least one mat element has an adhesive backing. This makes it possible to achieve a high-strength bond at certain points which also prevents slipping and uses the supporting effect of adjacent components, in particular a wall or body.

It is advantageous that at least one interior space is insulated from the outside by means of hybrid insulation. This allows the interior space to heat up quickly.

It is advantageous that at least one component, in particular a tank, further in particular a hot water tank, is insulated by means of the hybrid insulation with respect to its

surroundings. This means that the insulation concept can be used advantageously and, if necessary, in several places.

It is advantageous that at least one pop-up roof is insulated by means of the hybrid insulation from the surroundings of the recreational vehicle and preferably from an interior space of the recreational vehicle. This allows for optimized insulation of the sleeping area.

It is advantageous that a plurality of mat elements are replaced by just one cover element at least one location on the recreational vehicle. This makes assembly much easier. An insulating effect can be improved.

Depending on the design and application, one or more of the following features and advantages can be realized.

The main difference from previous insulation methods is that in addition to the PU mats, another material is preferably used for insulation. The second insulation is preferably made of PP fibers with a PET covering fleece on both sides. This is available in different material thicknesses and, due to its properties, can be easily compressed and processed. The fleece can be trimmed by the same supplier as the PU mats. The combination of the two materials can provide better thermal insulation and thus lower energy consumption.

Depending on the layout, such as windows, Thetford flap, external socket, etc., the insulation can be adapted.

A combination of PET covering fleece, PET fibers and PP fibers can be used as fiber material. The expanded material thickness can be 41 mm, although other thicknesses are possible. The weight can be 332 g/m\hat{ }2 (at 41 mm) or 8.1 kg/m2\hat{ }3. The thermal conductivity can be 0.05 W/mK. The fire behavior can be horizontally non-combustible according to FMVSS 302. Other properties may include: highly compressible; good reloft (high bulk or good re-swelling after being squeezed or compressed); water repellent or waterproof; not susceptible to mold; and ultrasonically weldable.

PU foam mats can be used as foam mats. It can be a foam which is open-celled and covered with skin, wherein self-adhesive properties can be realized via an adhesive layer. Material thicknesses can be 5 mm and 20 mm, although other thicknesses are possible. The weight can reach 24-27 kg/m\hat{ }3. The thermal conductivity can be (0.04+−0.005) W/mK. The temperature resistance can be −30° C. to briefly +130° C. The fire behavior can be <100 mm/min according to ISO 3795. Additional properties may include: one-sided adhesive backing; hydrophobic; dimensionally stable yet flexible.

Hybrid insulation can optionally be implemented more easily and cheaply, since, for example, more expensive PU foam mats can be replaced by cheaper fiber material.

By reducing the number of individual parts, assembly is generally quicker and easier. In addition, the fleece mat can preferably quickly and easily be removed from the vehicle and replaced or processed. This is usually not possible with PU mats due to the adhesive backing. Since the nonwoven mats preferably do not have an adhesive backing, waste is reduced by eliminating the need for plastics protective films.

Initial climate chamber tests with the fleece mats indicate better thermal insulation throughout the vehicle. The fleece can also provide greater sound insulation.

Different ways of attaching the insulation, such as with clips, screws, gluing, ultrasonic welding, etc., create a wide field of applications. In combination with variable trimmings, the fleece insulation can be easily adapted for new applications. This makes the new insulation method suitable for existing vehicle layouts as well as for future projects.

A preferred application is the insulation of interior spaces. However, it is also possible to insulate individual components, such as tanks or pop-up roofs.

Further advantages and details of the invention are explained in more detail with reference to the exemplary embodiments shown in the schematic figures. In the figures:

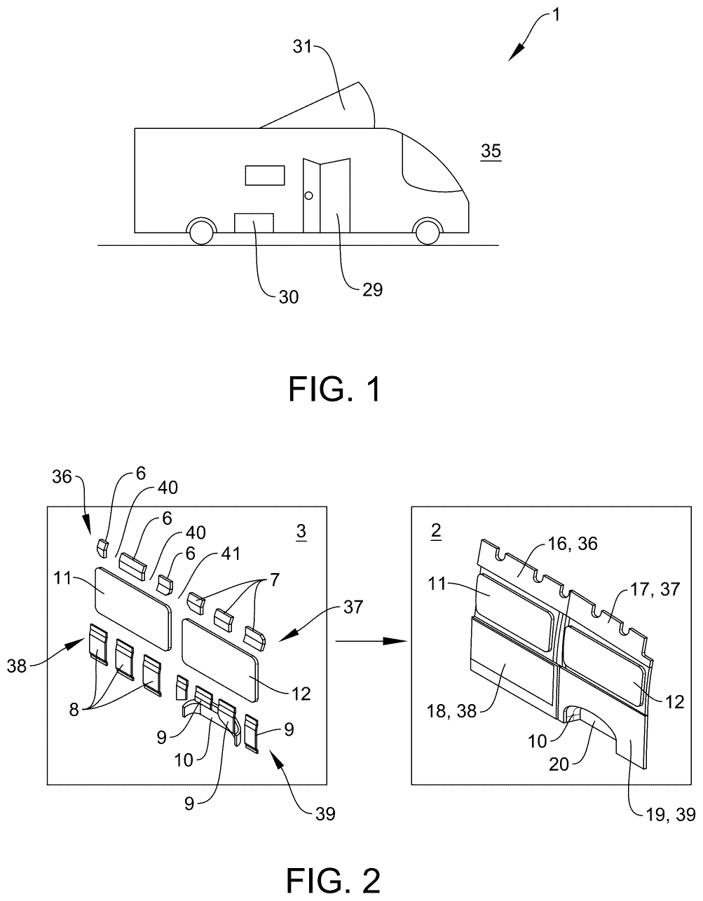

FIG. 1 shows a recreational vehicle in a schematic representation according to one exemplary embodiment of the invention;

FIG. 2 is a detail of the recreational vehicle shown in FIG. 1, illustrating a method for adapting insulation for a recreational vehicle;

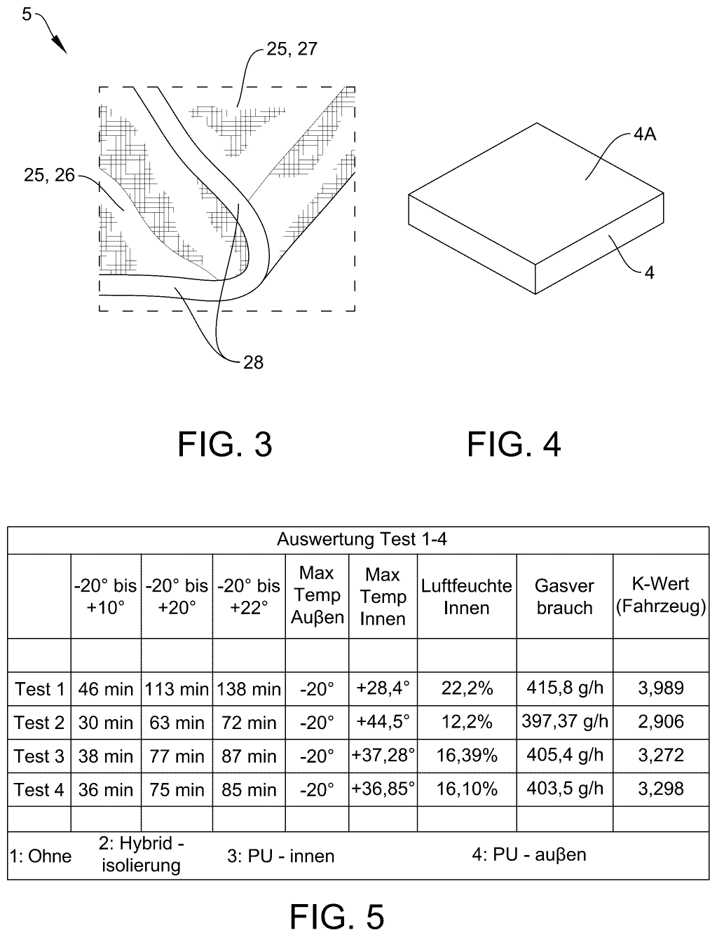

FIG. 3 shows a fiber material of a hybrid insulation for the recreational vehicle, which can be used for the adaptation illustrated in FIG. 2;

FIG. 4 shows a plastics foam mat of hybrid insulation for the recreational vehicle, which can be used for the adaptation illustrated in FIG. 2; and

FIG. 5 is a table with results of four tests demonstrating the effectiveness of the hybrid insulation.

FIG. 1 shows a recreational vehicle 1 in a schematic representation according to an exemplary embodiment of the invention. The recreational vehicle 1 can be designed in particular as a motorhome or caravan. The recreational vehicle 1 has a hybrid insulation 2 (FIG. 2). The hybrid insulation 2 is particularly suitable for such recreational vehicles 1.

FIG. 2 shows a detail of the recreational vehicle 1 shown in FIG. 1, wherein the structure of the hybrid insulation 2 and a method for adapting an insulation 3 for a recreational vehicle 1 are illustrated.

The hybrid insulation 2 for the recreational vehicle 1 is based on an insulation 3 with, in this exemplary embodiment, a plurality of mat elements 6, 7, 8, 9, 10, 11, 12 based on a plastics foam mat 4 (FIG. 4).

Furthermore, the hybrid insulation 2 for the recreational vehicle 1 in this exemplary embodiment has a plurality of cover elements 16, 17, 18, 19, 20 based on a fiber material 5 (FIG. 3).

FIG. 3 shows a fiber material 5 of a hybrid insulation 2 for the recreational vehicle 1, which can be used for the adaptation illustrated in FIG. 2. Furthermore, FIG. 4 shows a plastics foam mat 4 of the hybrid insulation 2 for the recreational vehicle 1, which can be used for the adaptation illustrated in FIG. 2.

The plastics foam mat 4 is at least substantially made of a polyurethane.

The fiber material 5 comprises fibers made of polyethylene terephthalate. Additionally or alternatively, it contains fibers made of polypropylene. In a preferred embodiment, the fiber material 5 is formed at least substantially from fibers made of polyethylene terephthalate and/or fibers made of polypropylene.

As shown in FIG. 3, the fiber material 5 in this exemplary embodiment is partially designed as a covering fleece 25, which is preferably formed at least substantially from fibers made of polyethylene terephthalate. In this exemplary embodiment, the fiber material 5 is formed with cover layers 26, 27. In this exemplary embodiment, both cover layers 26, 27 of the fiber material 5 are designed as a cover fleece 25 which is at least substantially made of fibers made of polyethylene terephthalate.

In this exemplary embodiment, the fiber material 5 also has a core 28. The core 28 of the fiber material 5 is at least substantially formed from hard and/or mechanically stable fibers. Preferably, the core 28 is formed at least substantially from polypropylene fibers.

The cover elements 16, 17, 18, 19, 20 are mounted without adhesive. Preferably, one or more of the cover elements 16, 17, 18, 19, 20 are mounted by simply inserting them between, for example, an inner wall and an outer wall or between other preferably flat elements without a direct integrally bonded connection. One or more cover elements 16, 17, 18, 19, 20 can also be fastened mechanically, in particular by clips and/or screws. In particular, the cover elements 16, 17, 18, 19, 20 can be mounted in such a way that they can be dismantled again later non-destructively. For example, if an exchange is to be carried out during a repair.

As shown in FIG. 4, the plastics foam mat 4 or the mat elements 6, 7, 8, 9, 10, 11, 12 can have an adhesive backing 4A. In this way, an integrally bonded connection can be realized. The plastics foam mat 4 therefore does not necessarily have to be self-stiffening or self-supporting. However, the adhesive backing 4A can also be omitted. In particular, a connection corresponding to the cover elements 16, 17, 18, 19, 20 can also be realized. Furthermore, the plastics foam mat 4 can optionally be glued with its adhesive backing 4A to a flat support means and then mounted together with the flat support means.

In one possible embodiment, an interior space 29 of the recreational vehicle 1, in particular a living area 29, can be insulated from the outside by means of the hybrid insulation 2.

In a further possible embodiment, at least one component 30, in particular a tank 30, can be insulated by means of the hybrid insulation 2. This optionally allows optimized frost protection to be achieved. In particular, a hot water tank 30 can also be insulated from its surroundings by means of the hybrid insulation 2. For example, the hot water tank 30 can be heated during the day by means of solar energy, in particular by water loops running across the roof.

In another possible embodiment, a pop-up roof 30 can be insulated by means of the hybrid insulation 2 with respect to the surroundings 35 of the recreational vehicle 1 and preferably can from an interior space 29 of the recreational vehicle 1. Due to the insulation of the interior space 29, heating of the interior space 29 is not necessary, in particular at night, and therefore energy can be saved.

In the expanded state, the fiber material 5 can have a material thickness between about 2 cm and about 8 cm. For example, 2 cm may be sufficient for additional insulation in the region of a rear garage. A material thickness of 8 cm can be advantageous for a hot water tank. Specifically, the material thickness can be between about 2.7 cm and about 6 cm in order to achieve an advantageous optimization in terms of the insulating effect and the use of materials. In this regard, between about 3.4 cm and about 4.9 cm, and more particularly between 3.7 cm and 4.5 cm, are particularly advantageous. In a series of tests (FIG. 5), a material thickness of about 4.1 cm proved to be advantageous.

The hybrid insulation 2 can advantageously be carried out on an insulation 3 which may optionally already have been realized on the basis of a plastics foam mat 4. In this case, a method for adapting an insulation 3 for a recreational vehicle 1, which insulation has mat elements 6, 7, 8, 9, 10, 11, 12 based on a plastics foam mat 4, can also be realized. This is also explained in more detail with reference to FIG. 2.

In this exemplary embodiment, mat elements 6, 7, 8, 9 are provided, each provided with corresponding reference signs 6, 7, 8, 9, which each insulate a location 36, 37, 38, 39. This part 6, 7, 8, 9, 10 of the mat elements 6, 7, 8, 9, 10, 11, 12 of the insulation 3 is replaced by cover elements 16, 17, 18, 19, 20 based on the fiber material 5 to form the hybrid insulation 2. Thus, at at least one location 36, 37, 38, 39 of the recreational vehicle 1, a plurality of mat elements 6, 7, 8, 9 can be replaced by only one cover element 16, 17, 18, 19.

Since the mat elements 6, 7, 8, 9 only partially cover the positions 16, 17, 18, 19, the mat elements 6, 7, 8, 9 are also supplemented in the gaps 40, 41. To simplify the illustration, only the gaps 40 between the mat elements 6 and the gap 41 between the mat elements 6, 7 are marked.

Furthermore, the mat element 10 is partially replaced by the mat element 20. This allows, for example, advantageous adjustments to be made in specific places, such as a wheel arch here.

The mat elements 11, 12 based on the plastics foam mat 4, in particular a PU plastics foam mat 4, are retained. However, when adapting an insulation concept for a recreational vehicle which is based on insulation 3 on the basis of the plastics foam mat 4, it is possible to adapt, for example, a thickness and/or area of the mat elements 11, 12 and/or possibly also the plastics material or plastics materials for the production of the plastics foam mat 4 in order to realize the hybrid insulation 2 for the recreational vehicle 1.

FIG. 5 shows a table with results of four tests demonstrating the effectiveness of the hybrid insulation. Here, test 1 shows results for a condition of a recreational vehicle without insulation 3. Test 2 shows results for the hybrid insulation 2. Test 3 shows results for an internally applied insulation 3 based on a PU plastics foam mat 4. And test 4 shows results for an externally applied insulation 3 based on a PU plastics foam mat 4.

The climate tests illustrated in FIG. 5 show that the hybrid insulation 2 tested in test 2 achieves shorter heating times, a higher maximum interior temperature, lower gas consumption and a higher K-value.

It is understood that the values given in the table in FIG. 5 depend on the specific recreational vehicle 1, in particular the geometries and the installed heating. Furthermore, there is freedom in the realization of the hybrid insulation 2, in particular with regard to optimizing the use of materials and the achieved insulating effect, which may lead to different results. However, the table illustrates the basic advantages of the hybrid insulation 2. The invention is not limited to the exemplary embodiments described.

1. Hybrid insulation for a recreational vehicle, in particular a motorhome or a caravan, with at least one mat element based on a plastics foam mat,
characterized in that
at least one cover element based on a fiber material is provided.

2. Hybrid insulation according to claim 1,
characterized in that
the plastics foam mat is formed at least substantially from a polyurethane.

3. Hybrid insulation according to claim 1,
characterized in that
a) the fiber material comprises fibers made of polyethylene terephthalate and/or fibers made of polypropylene and/or
b) the fiber material is formed at least substantially from fibers of polyethylene terephthalate and/or fibers of polypropylene.

4. Hybrid insulation according to claim 1,
characterized in that
a) the fiber material is at least partially designed substantially as a covering fleece, which in particular is formed at least substantially from fibers made of polyethylene terephthalate, and/or
b) at least one cover layer, preferably both cover layers, of the fiber material is or are designed as a covering fleece which in particular is formed at least substantially from fibers made of polyethylene terephthalate and/or
c) a core of the fiber material is formed at least substantially from hard and/or mechanically stable fibers, in particular at least substantially from fibers made of polypropylene.

5. Hybrid insulation according to claim 1,
characterized in that
the fiber material in the expanded state has a material thickness between about 2 cm and about 8 cm, in particular between about 2.7 cm and about 6 cm, further in particular between about 3.4 cm and about 4.9 cm, further in particular between 3.7 cm and 4.5 cm, further in particular about 4.1 cm.

6. Hybrid insulation according to claim 1,
characterized in that
a) the at least one cover element can be mounted without adhesive and/or by insertion without a direct integrally bonded connection and/or
b) the at least one cover element is mounted in such a way that it can be dismantled non-destructively.

7. Hybrid insulation according to claim 1,
characterized in that
the at least one cover element can be fastened mechanically, in particular by clips and/or screws.

8. Hybrid insulation according to claim 1,
characterized in that
the at least one mat element has an adhesive backing.

9. Recreational vehicle, in particular a motorhome or caravan, comprising at least one hybrid insulation according to claim 1.

10. Recreational vehicle according to claim 9,
characterized in that
a) at least one interior space is insulated from the outside by means of the hybrid insulation and/or
b) at least one component, in particular a tank, further in particular a hot water tank, is insulated with respect to its surroundings by means of the hybrid insulation and/or
c) at least one pop-up roof is insulated by means of the hybrid insulation with respect to the surroundings of the recreational vehicle and preferably with respect to an interior space of the recreational vehicle.

11. Method for adapting an insulation for a recreational vehicle which has mat elements based on a plastics foam mat,
characterized in that
a part of the mat elements is replaced and optionally supplemented by cover elements based on a fiber material to form a hybrid insulation according to claim 1.

12. Method according to claim 11,
characterized in that
at least one location of the recreational vehicle a plurality of mat elements are replaced by only one cover element.
